(19) United States
(12) Patent Application Publication
(10) Pub. No.: US 2022/0043483 A1
(43) Pub. Date: Feb. 10, 2022

(54) Multimedia desktop, permanet or portable system

(71) Applicants: Stephen G. Ehrman, Indianapolis, IN (US); Damian J Ehrman, Indianapolis, IN (US)

(72) Inventors: Stephen G. Ehrman, Indianapolis, IN (US); Damian J Ehrman, Indianapolis, IN (US)

(21) Appl. No.: 16/988,680

(22) Filed: Aug. 9, 2020

(51) Int. Cl. G06F 1/16; G06F 1/20

(52) U.S. Cl. CPC G06F 1/1633; G06F 1/206; G06F 1/1605

(57) ABSTRACT

A multimedia entertainment and communication system providing the full features of a state of the art mobile device that is made and optimized to be used in a home, business or other stationary, fixed or permanent application. The system has two parts, one is the outer shell or housing and the second is an assembly to which all main supporting electrical devices are installed which also serves as a physical support for the main multimedia device. The outer shell is designed of a size, and with openings such that the internal assembly is inserted into the first housing to make a complete system.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF INVENTION

### Field of the Invention

The present invention is within the technical field of multimedia devices. More particularly, the present invention relates to a fully functional multimedia system, assembly of supporting electrical and mechanical devices and engineered enclosure.

### Description of the Related Art

Mobile audio and video entertainment systems are rapidly advancing in complexity and functionality while scale of production provides a lower cost. Early mobile audio systems included only AM-FM radio, later added tape decks and other audio interface. Currently there exist many options for playing, displaying, and interfacing multimedia on devices designed for mobile applications in automobiles, recreational vehicles, watercraft, and the like. These devices continue to develop quickly including intuitive and easy to use features. Additionally, display sizes are expanding, and interface software allows quick connections to personal communication devices (I-phones, I-pads and Androids, etc.) allowing access to that devices' content. Bluetooth included in these devices provides interface to hands free telephone calls and storage of phone books. Computer processors are being integrated in these mobile multimedia devices allowing interface to the web, thereby offering the complete services of internet tools, and applications (APPS). There are also integrated or plug-type inputs for other media such as television HDTV signals, voice recognition, and the like, all while reducing in costs and minimizing total device volume size. These devices are being designed to work well in a cabin of a vehicle, operate with other vehicle mounted devices such as a quality cabin mounted microphone for voice commands and phone conversations, and paired with different supporting devices such as speakers, and surrounding and reverse view cameras. Given all the features included, the developers take great care to design these devices to be user friendly, so they are not a distraction to a driver and passenger while operating or riding in a vehicle. However, these devices are designed to be powered by a 12 or 24 volt DC electrical service commonly used in automobiles or mobile vehicles, and require the aforementioned devices such as speakers and microphones as well as a physical mounting support provided in vehicles. For these reasons, these very useful multi-media devices cannot intuitively be easily used in a home, office or otherwise where the large variety of features provided at low costs is beneficial and desirable.

Further, there exist simple home and portable devices, designed to sync up to personal communication devise such as I-phones, I-pads, Android devices and the like.

However, these devices are typically very simplistic, have limited range of features, difficult to operate and not physically designed for good sound quality. Due to their size, and the crowded market, they are designed inexpensively with low quality components. Current products are known as Bluetooth soundbar and the like. Commonly this device does not optimize and enhance acoustics, rather just a loud-speaker and may also provide a very small microphone that is usually substandard for clarity of phone calls.

Additionally, there are devices that are higher quality, incorporating analog, HD, and wi-fi radio and cd media playing, but are mainly audio devices only, and do not include many of the features of a mobile multi-media type device described above. Further the methods of use and interface are different for each manufacturer and device, making them cumbersome to use.

Additionally, many energy and safety technological developments for home including home security, HVAC comfort, lighting, energy management including solar systems, and VIoP phones have separate operator interface devices. Additionally, many of these home systems now also have Bluetooth or wi-fi to communicate thru readily available applications (Apps). Using these apps in an otherwise mobile multimedia device has been made intuitive. Therefore, if otherwise mobile multimedia devices are able be used in a home or office, this provides one device to consolidate all the home and office systems making the home or office safer, energy efficient and more convenient and user friendly.

Additionally, powering a typical audio AM-FM car radio on home power source in a stationary position has been done for years where DIY's use a stand-alone 110 v to 12 v power transformer and separately wire external speakers. But, doing so with the more complex, physically larger LCD touch screen, DIN2 style mobile multi-media device, inserting into an acoustically optimized housing and incorporating an assembly for physical support, containing other devices, prewired and arranged in such a way that is reliable to be mass produced and cost effective, is not similarly intuitive.

Therefore there exists a need for providing all the benefits and attributes, features and options of the readily available mobile features which can be used in a home, office or like, powered by 110 v, or similar AC electrical circuit, contained within an acoustically optimized cabinet to provide ease and familiarity of operation, a full range of multi-media operation, ease of syncing to other users devices and wi-fi. The present device provides these attributes.

### BRIEF SUMMARY OF THE INVENTION

It is an object of the present invention to provide a low-cost high quality, highly functional assembly of a stationary multimedia device. The present invention is an assembled multi-media device providing easy to operate features such as audio, video, internet, applications (Apps) and the like, that is intuitive, familiar to the user and easy to operate. The invention is mounted within an acoustically complimentary housing which is designed to be aesthetically pleasing for use on a bookshelf, or desk. The invention includes a common multi-media device mounted in a structure designed to both physically and electrically support a multimedia device and necessary accessories, providing convenient, prewired necessary electrical support and interface components such as 110 v to 12/24 Vdc and 5Vdc power supply transformer(s), audio speakers, audio microphone, Digital TV signal converter, and provide external connections using standard plugs for items such as antenna, security camera, external audio speakers, video input, USB connection to other devices and USB power, the 110 V plug or power connection, 12 v memory back up power battery, wireless charging stations, and other such items as standard or offered as accessories. It is a second object of the invention to provide the inner assembly designed to be mass produced and easily inserted into an acoustically optimized, atheistically pleasing housing. It is a third object of the invention to provide the inner assembly designed to be installed permanently within cabinetry, structure or walls making audio connections to remote speakers and accessories.

In one embodiment of the present invention, all devices are mounted into the internal assembly having carefully coordinated openings that relate to the outer assembly. The inner assembly then can be inserted into the acoustically optimized outer housing so that the completed assembly becomes an acoustically sealed device, of a size and weight that allows it to be placed on a common bookshelf, desk, table top or the like.

In a second embodiment of the present invention, the invention is much like the first embodiment, however not all devices are mounted into the internal assembly, rather the supporting accessories, such as speakers, charging stations and microphone(s), may be provided separately and wired or wirelessly connected to make a complete system.

In a third embodiment of the present invention, the invention is much like the second embodiment, but the electrical devices and mechanical supports are constructed on a smaller internal assembly designed to be installed in a more permanent position such as a wall or cabinet, while the supporting accessories are also provided separately and connected wired or wirelessly. Such supporting accessories are items such as speakers, charging stations microphone(s) and the like.

### BRIEF DESCRIPTION OF THE DRAWINGS

Preferred and other embodiments of the present invention are illustrated as examples below and the invention should not be limited by figures of drawings, in which like references may indicate similar elements in which:

FIG. 1 is a perspective view of the present invention according to and including the preferred embodiment

FIG. 2 is a rear perspective view of the present invention according to and including the preferred embodiment

FIG. 3 is a rear-side view of the present invention according to and including the preferred embodiment

FIG. 4 is a front perspective view of the internal insert of the present invention according to and including the preferred embodiment

FIG. 5 is a corner overall perspective view of the insert of the present invention according to and including the preferred embodiment

FIG. 6 is a top front view of the insert of the present invention according to and including the preferred embodiment

FIG. 7 is a rear view of the insert of the present invention according to and including the preferred embodiment

FIG. 8 is a topical representation of electrical components of the present invention according to and including the preferred embodiment

FIG. 9 is a perspective view of an alternate arrangement of the present invention according to and including the third described embodiment

FIG. 10 is a top-rear perspective view of the alternate arrangement of the present invention according to and including the third described embodiment

FIG. 11 is a side-rear view of the alternate arrangement of the present invention according to and including the third described embodiment.

### DETAILED DESCRIPTION OF THE INVENTION

The terminology used herein is for the purpose of describing embodiments only and is not intended to be limiting of the invention. As used of singular terms “a”, “an”, “the” and similar are intoned to include also plural forms unless the context of use clearly depicts singular reference.

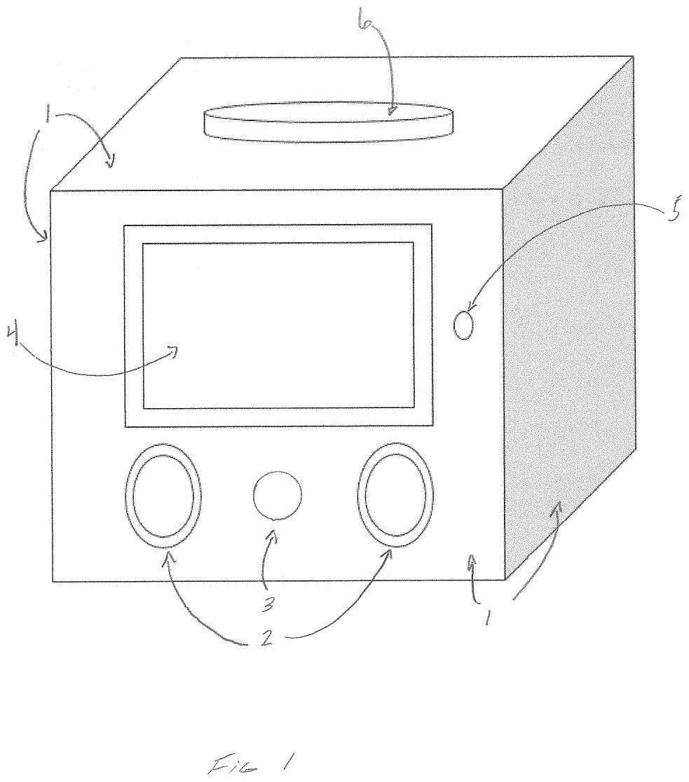

Turning first to FIG. 1, the typical multi-media enclosure is shown with a plurality of sides to make enclosure 1, this example containing two sides, a top, bottom and front face. The front face contains openings for the multi-media touch screen user interface and display 4, high and mid frequency range speakers 2, an acoustical opening 3 for low frequency sounds, commonly called bass, to reverberate into the users direction, and a high efficient microphone 5 of the condensing or other amplifying or high efficiency type. The top side 1 may include a wireless charging pad 6 that is internally powered from the unit. The size is acoustically optimized for the speakers' frequency response, and of a shape and material such as wood, metal or plastic that is aesthetically pleasing and physically supportive.

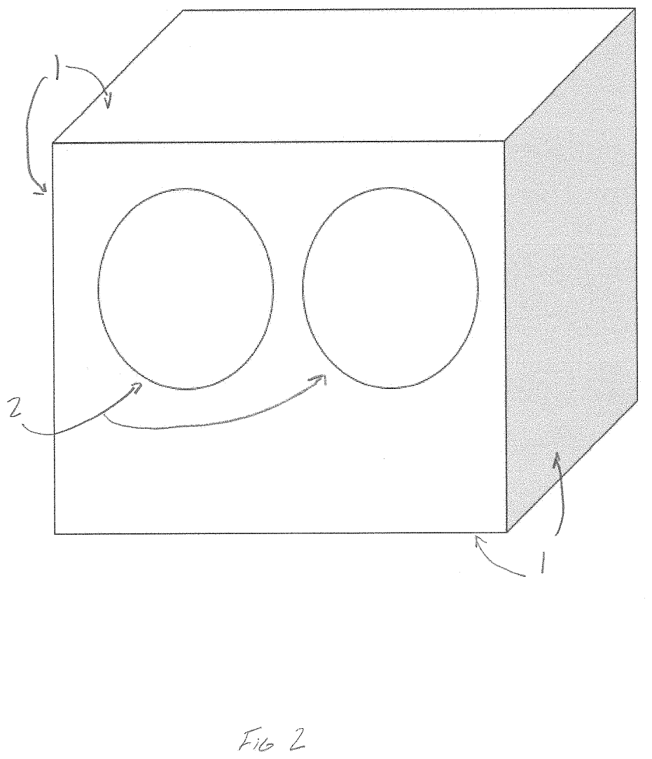

FIG. 2 shows the rear of the invention with the internal insert already installed that is described in more detail below. In this figure, two round openings are depicted 2 where a set of speakers are mounted rear facing to produce mid-to-low frequency sound. The energy created from these speakers also is radiated forward thru the acoustical opening described above.

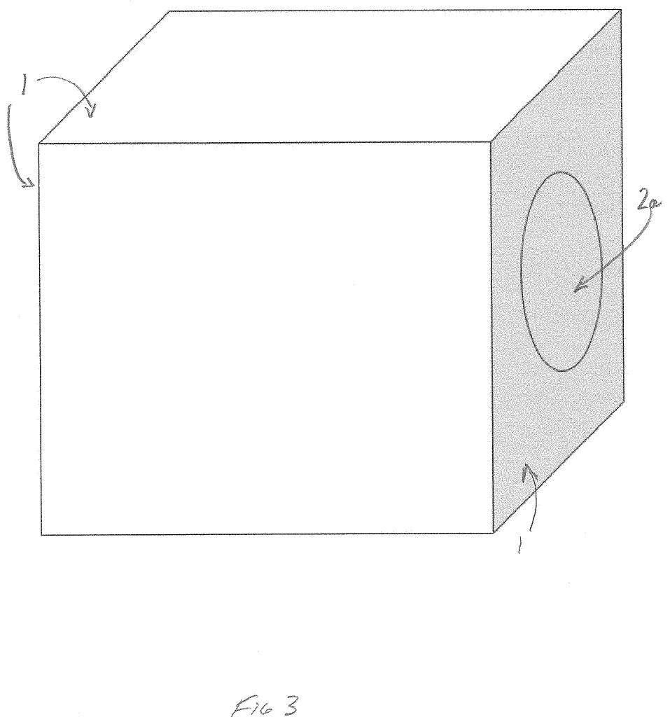

FIG. 3 shows a rear view where the openings for the speakers 2a described above are not mounted in the rear panel but instead are optionally mounted in the sides of the insert and align with an opening in the outside cabinet.

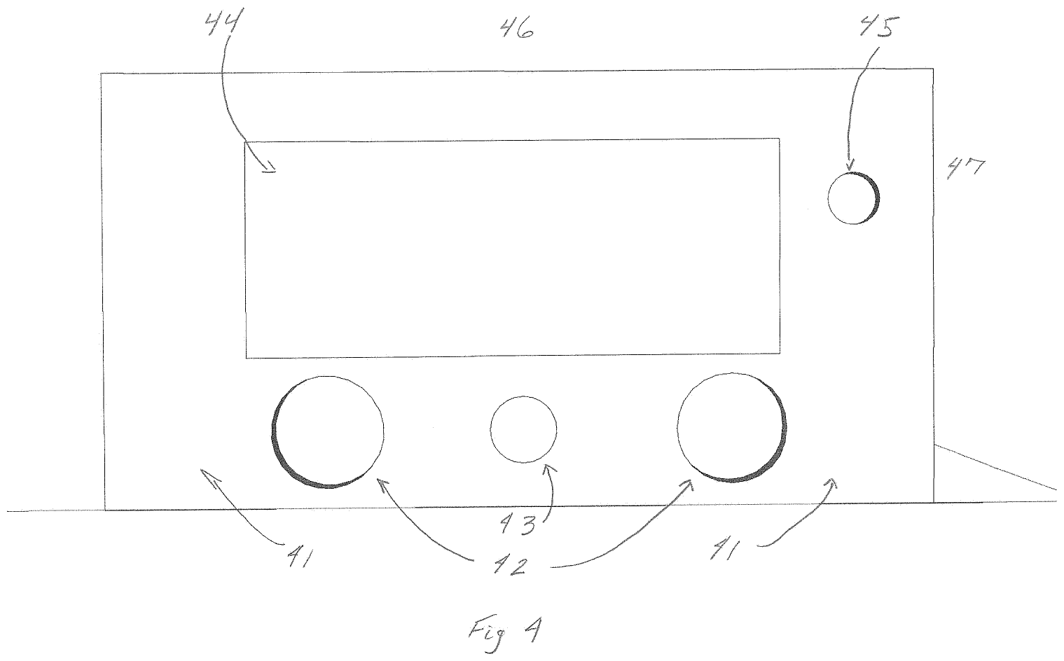

Turning now to the insert support and assembly that is installed inside the above described outer enclosure, FIG. 4 shows the multi-media device mounted in and supported from the structure is the touch screen 44 which then protrudes thru the outer enclosure opening so that it is accessible to the user. Openings 42 exist where the mid and high range speakers are mounted and align with the FIG. 1 openings depicted above 2. The acoustical opening is shown 43 where sound radiates from the enclosure outward toward the user. This opening additionally provides ventilation for internal electrical heat to dissipate. 41 is the flat front surface area of the insert.

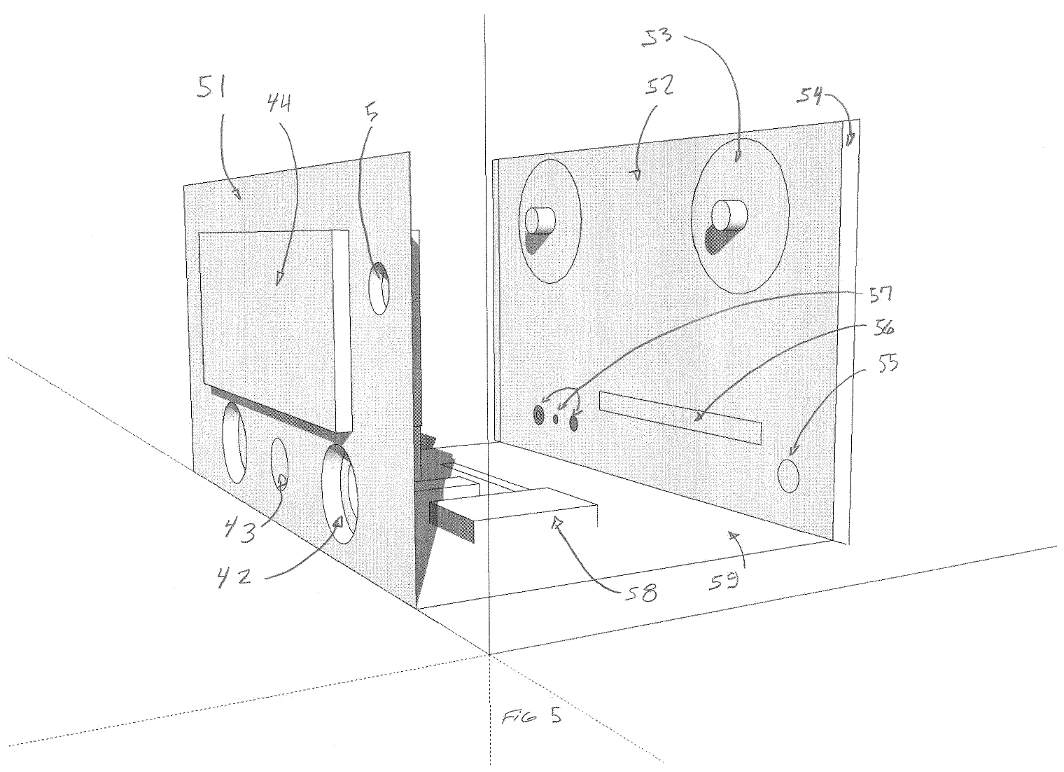

FIG. 5 depicts a side view of the insert assembly containing the front 51 back 52 and bottom 59 joined at seams or bent from a single piece of metal or other supporting material and includes extensions 54 that provide an acoustical air seal to the rear opening when mated to the outer housing. Openings 57 are a single or plurality of connection openings for miscellaneous externally connected devices that may include antenna, temperature sensors, external microphone and the like. A series of other connections for external interface are provided with connection 56 and may include alternate remote speaker's outputs and inputs for devices such as other audio, video and cameras and the like. An opening 55 depicts the main supply power connector entry for lines carrying 110V or 220V AC supplying main power connecting to a power transformer 58 with said device converting main voltage to the voltage required for the multi-media device such as 12 V DC or 24 V DC.

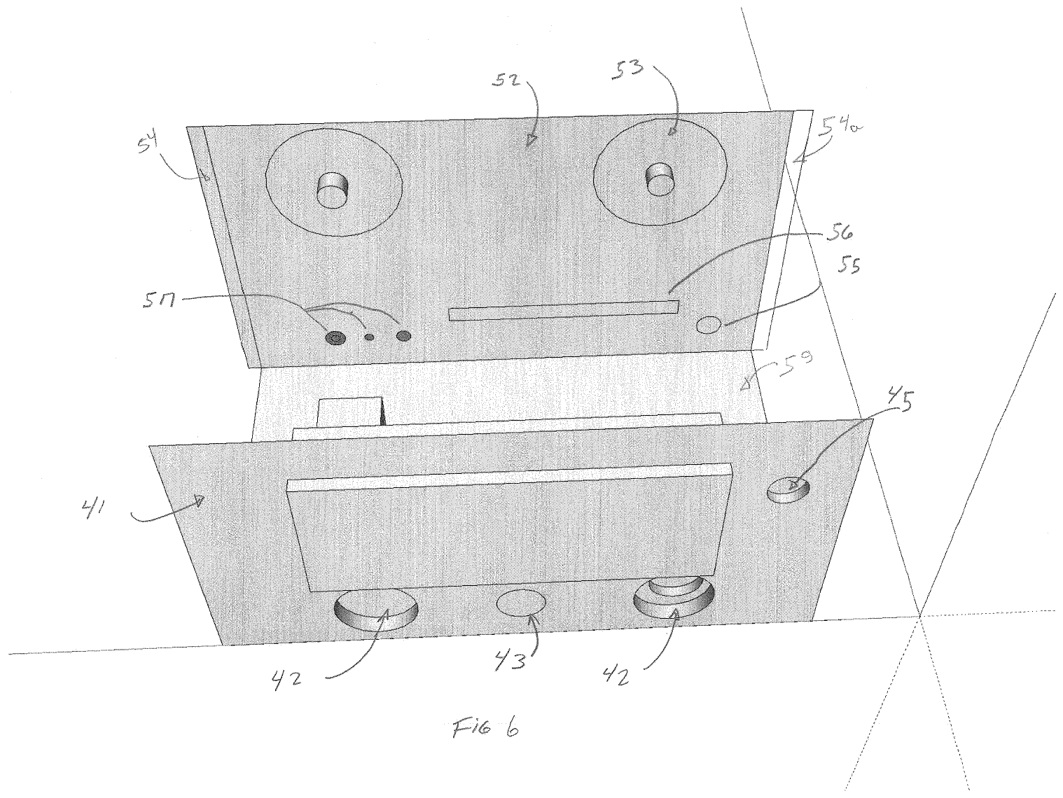

FIG. 6 details the internal insert assembly showing the extension acoustical air seal 54 and 54a also shown without shading to help visualize and understand how these extensions overlap the rear material thickness of the outer assembly.

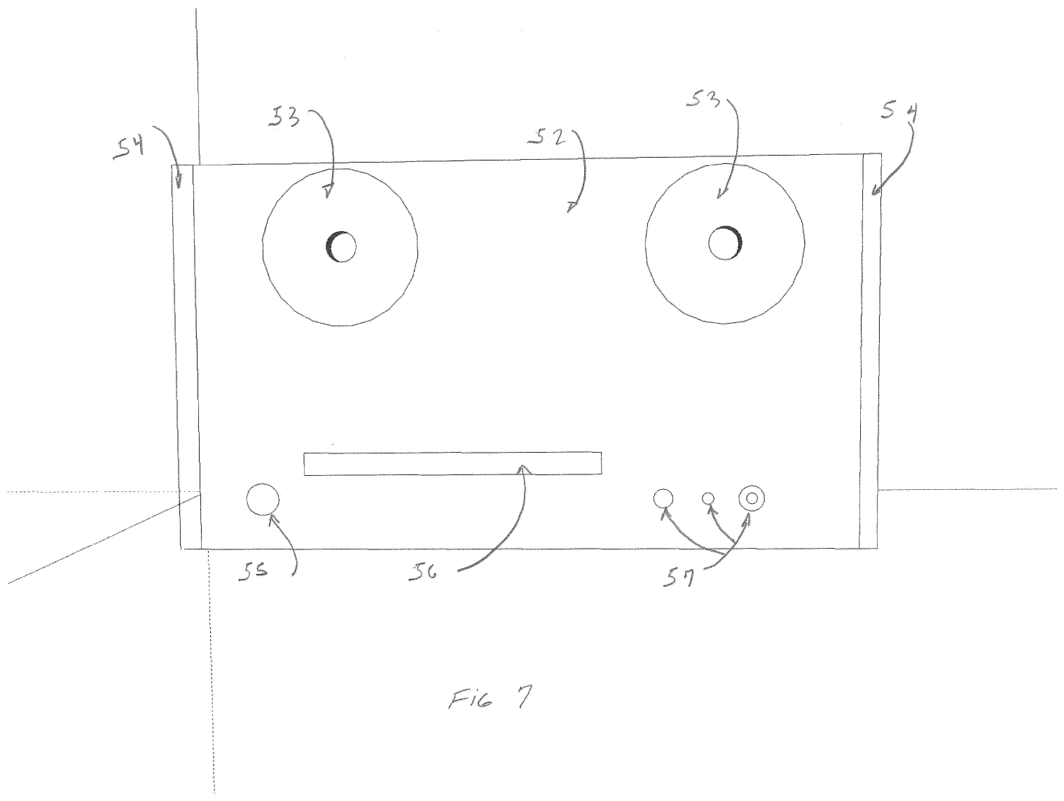

FIG. 7 depicts a rear view of the insert with many of the same items included and details as described above.

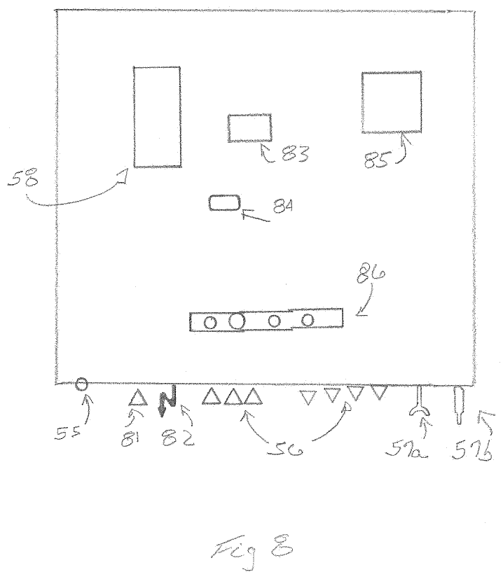

FIG. 8 diagrammatically provides reference to some of the main electrical support devices and connections depicting the previously mentioned main power transformer 58, power cord opening 55, and audio and videos inputs and outputs 56 and other devices such as an antenna connection 57a and temperature measurement 57b. Additional interface devices such as 84 is a step-down transformer to use with other devices such as USB power and wireless charging station requiring 5 VDC, and other devices 83 and 85 such as Digital TV converter and other video interface. Items 86 is a two sided terminal strip where the external wire connections from outside connectors 55,81,82,56,57a,57b are terminated on one side, then other side wired to the internal devices such as 58,83,84,85, the main multimedia device and the like.

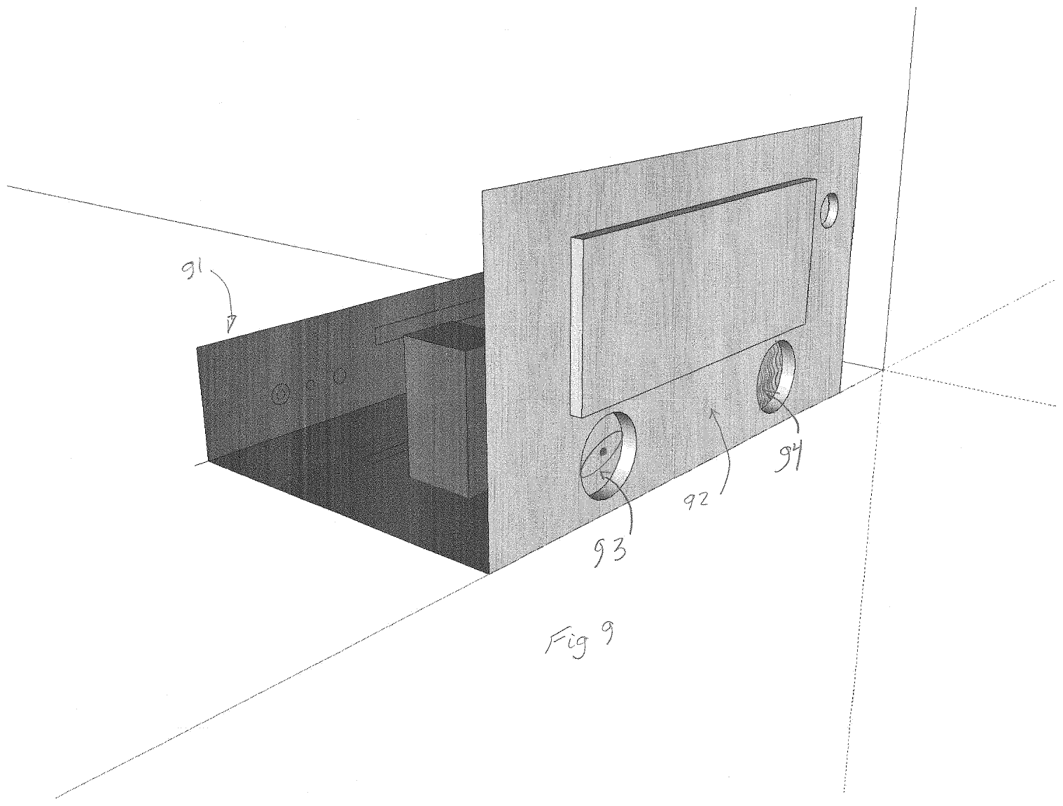

FIG. 9 depicts an alternate arrangement where the insert assembly is designed to fit into a cabinet, wall, or other permanent structure. The face 92 does not include an acoustical opening because the rear side 91 is shortened and does not contain the low frequency speakers, such that they are instead separately provided if desired to be added to the system. The unit can be ventilated by brining in air thru an opening with mesh or similar covering 94 and may be powered by a ventilation fan 93.

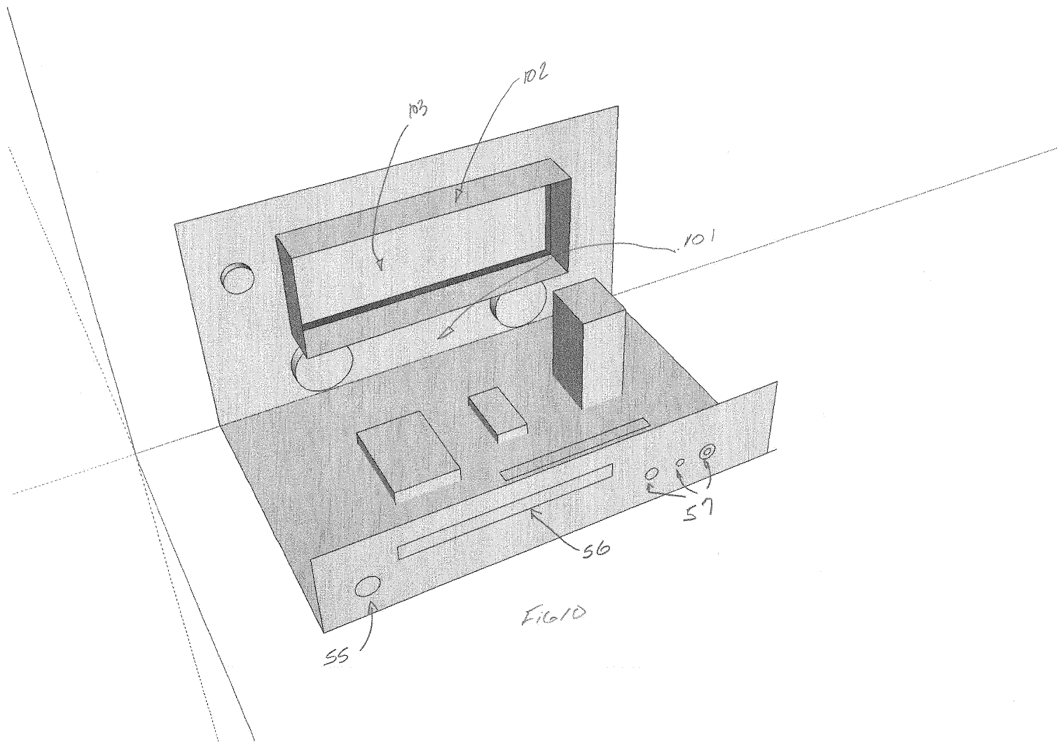

FIG. 10 further depicts the alternate arrangement in a rear view of the same modified assembly described in FIG. 9, and the rear view of the front plate 101 not containing an acoustical opening but supporting 102 and providing an opening 103 for the multi-media device.

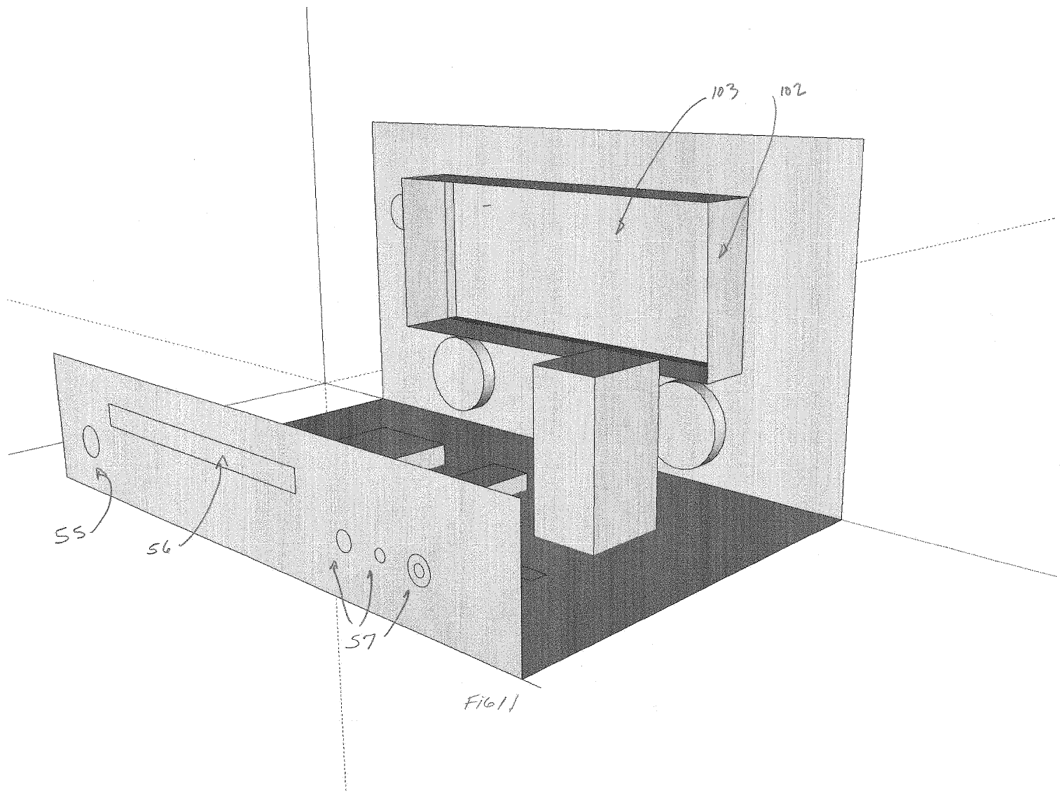

FIG. 11 is an additional rear side view of the alternate arrangement described in FIGS. 9 & 10 above.

The advantages of the present invention include, without limitation, the ability to use mass produced electronic multimedia units that offer state of the art, highly functional, easy to operate, low cost devices that otherwise are only applied in mobile applications such as automobiles and allow use of these devices in home, office or other stationary settings. Doing so provides a user convenience, entertainment, familiarity of function, energy savings, safety and security all consolidated in one device. Most of these benefits being described herewith or of common knowledge, additional details of some of the functions include; Safety and security in home or office provided by wireless access to the central system including lighting, back up main power, and remote cameras. Further, convenience and security are realized with easy VoIP (Voice over Internet Protocol) phone access for quick and easy access. Energy savings is realized using wireless connectivity to energy systems such as solar systems, using device and management applications. Environment alarms can also be integrated such as low and freezing house temperatures, high water in basements for flood monitoring including operation of sump pumps. Further convenience is the touch screen note pad app and more broadly all of the applications (APPS) that a person or family may regularly use, contained on this one central device that a home or business owner can more easily use and share complete or limited access with others.

In broad embodiment, the present invention is an acoustically optimized housing and assembly of a multi-media device designed to be installed in stationary places, that is affordable, familiar to the user, and highly functional.

While the foregoing written description of the invention enables one of ordinary skill to make and use what is considered presently to be the best mode, and understand the variants also disclosed, those of ordinary skill will understand and appreciate the existence of other variations, combinations, and equivalents of the specific embodiment, method, and examples herein. The invention should therefore not be limited by the above described embodiments, methods of constructions and assembly, and examples, but by all embodiments and methods within the scope and spirit of the invention.

We claim:

1. A stationary multimedia device comprising:
a fully functional multi-media system;
an outer enclosure creating a housing for the system components;
an internal assembly of the system components constructed to be easily inserted into the outer housing.

2. The stationary multimedia device of claim 1, further comprising:
the outer enclosure being acoustically optimized in size to the specification of the sound system components providing best amplification and efficiency;
the internal assembly of components constructed to be a physical support and mounting platform for all of the devices of the system;
the internal assembly, containing wiring and electrical devices needed to support and interconnect the system.

3. An outer cabinet or housing comprising:
a plurality of sides arranged to make an enclosure constructed of material that may be aesthetically pleasing;
one side open in the rear to allow receiving an internally inserted assembly of components;
said housing having strategically and dimensionally coordinated openings for the user display interface surface of the multimedia device, speakers, microphone, wireless and wired charging stations and the like.

4. An assembly of electrical components and mechanical supports onto a frame comprising:
a plurality of sides for supporting a device mounted on such frame;
having physical attribute of sufficient rigidity to support components;
having openings and holes purposely located and coordinated to match openings in the outer shell.

5. The assembly of claim 4 mounting and support additionally having the attributes of;
shortened front, side and rear walls so as not to include the rear or front speakers or acoustical opening;
designed to mount permanently in a wall or home or office or the likes of a cabinets, desk or other furniture;
containing the necessary physical support, electrical power, and connections for all integrated or remote devices, additional remote connections such as speakers; having ventilation opening or fans necessary to dissipate electrical heat.
